(19) United States
(12) Patent Application Publication
(10) Pub. No.: US 2013/0255984 A1
(43) Pub. Date: Oct. 3, 2013

(54) IMPACT DEVICE FOR AN ELECTRIC NAIL GUN

(71) Applicant: BASSO INDUSTRY CORP., Taichung (TW)

(72) Inventor: Chien-Kuo Po, Taichung (TW)

(73) Assignee: BASSO INDUSTRY CORP., Taichung (TW)

(21) Appl. No.: 13/841,669

(22) Filed: Mar. 15, 2013

(30) Foreign Application Priority Data
Mar. 28, 2012 (TW) 101110812

(51) Int. Cl. B25C 1/06

(52) U.S. Cl. CPC B25C 1/06
USPC 173/112

(57) ABSTRACT

An impact device is used for an electric nail gun. The electric nail gun includes a supporting frame, a flywheel disposed pivotally on the supporting frame, and a swing arm disposed pivotally on the supporting frame. The impact device includes a sliding block disposed movably on the supporting frame, a nail striker rod connected to the sliding block, and an impact block floatable on the sliding block. When the swing arm rotates toward the flywheel, it presses the impact block against the flywheel to thereby move the sliding block from a pre-firing position to a firing position. Since the impact block is not co-rotatable with the swing arm, it can be designed to move in a direction the same as that of the nail striker rod, thereby facilitating smooth firing operation.

### CROSS-REFERENCE TO RELATED APPLICATION

This application claims priority of Taiwanese Application No. 101110812, filed on Mar. 28, 2012.

### BACKGROUND OF THE INVENTION

1. Field of the Invention

This invention relates to a pneumatic tool, and more particularly to an impact device for an electric nail gun.

2. Description of the Related Art

Referring to FIGS. 1 and 2, a conventional electric nail gun 1 disclosed in Taiwanese publication No. 201136718 includes a base 10, a nail passage 11 formed in a side portion of the base 10, a driving unit 12, a transmission unit 13, and an impact unit 14. The driving unit 12 includes a flywheel 121 disposed pivotally on the base 10, and a motor 122 for driving rotation of the flywheel 121. The transmission unit 13 includes a swing arm 131 disposed on the base 10 and swingable relative to the flywheel 121. The impact unit 14 includes a guide rod 141 extending in the swing arm 131 along a nail-striking direction, an impact block 142 slidable along the guide rod 141, and a nail striker rod 143 connected to the impact block 142 and aligned with the nail passage 11.

The impact block 142 is connected to the swing arm 131. When the swing arm 131 rotates toward the flywheel 121, the impact block 142 comes into contact with the flywheel 121. Upon frictional contact of the impact block 142 with the flywheel 121, the impact block 142 is driven by the flywheel 121 to move in the nail passage 11 along the nail-striking direction so as to perform a nail striking operation.

However, since the impact block 142 is swingable with the swing arm 131, and since the nail striker rod 143 is disposed fixedly on the impact block 142, when the impact block 142 is co-rotated with the swing arm 131 to separate from the flywheel 121, an angle is formed between the nail striker rod 143 and the nail passage 11. Although the angle can be reduced when the swing arm 131 rotates toward the flywheel 121, the moving direction of the impact block 142 may be different from the nail-string direction of the nail striker rod 143, thereby affecting adversely smooth nail striking operation.

### SUMMARY OF THE INVENTION

The object of this invention is to provide an impact device for an electric nail gun that can be operated to perform a more smooth nail striking operation.

According to this invention, an impact device is used for an electric nail gun. The electric nail gun includes a supporting frame, a flywheel disposed pivotally on the supporting frame, and a swing arm disposed pivotally on the supporting frame. The impact device includes a sliding block disposed movably on the supporting frame, a nail striker rod connected to the sliding block, and an impact block floatable on the sliding block. When the swing arm rotates toward the flywheel, it presses the impact block against the flywheel to thereby move the sliding block from a pre-firing position to a firing position.

Since the impact block is not co-rotatable with the swing arm, the moving direction of the impact block can be designed to be the same as the nail striking direction of the nail striker rod, thereby facilitating smooth nail striking operation.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 a partially exploded perspective view of a conventional electric nail gun disclosed in Taiwanese publication No. 201136718;

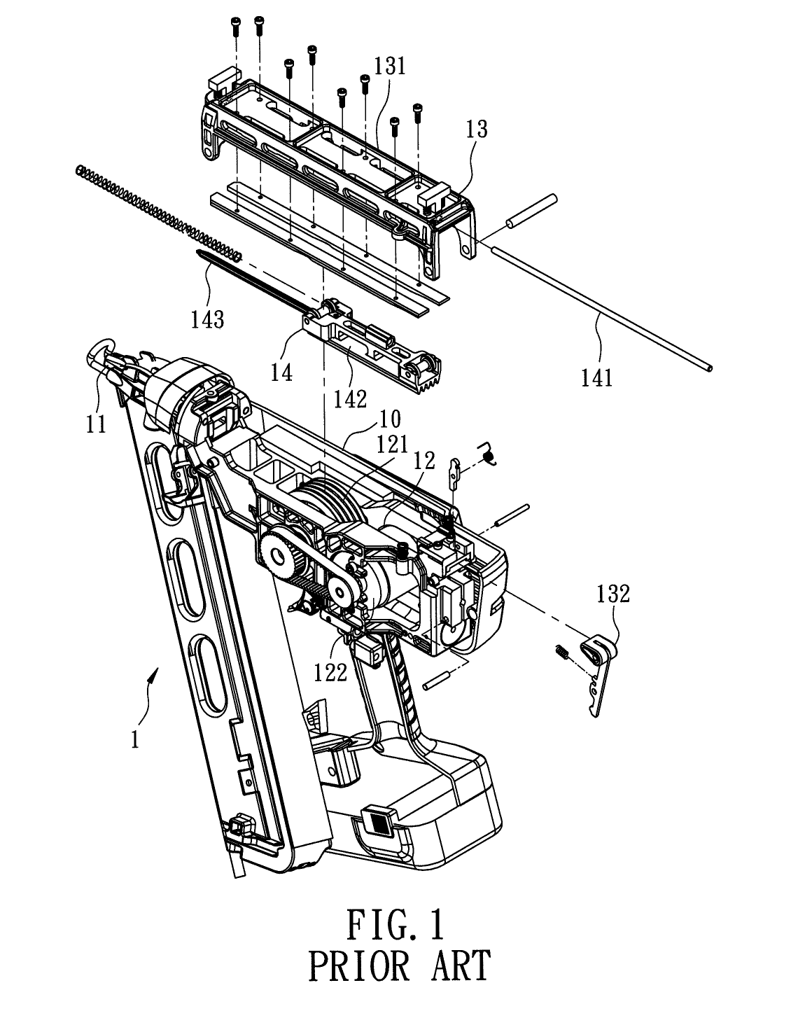

FIG. 2 is a fragmentary side view of the conventional electric nail gun;

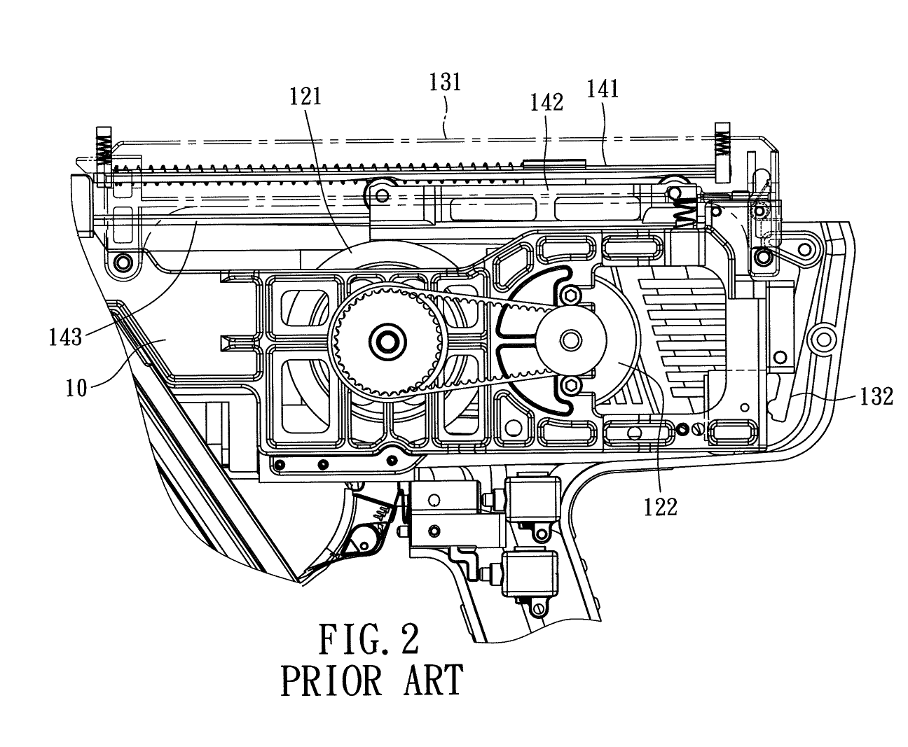

FIG. 3 is a partially exploded perspective view of an electric nail gun including the preferred embodiment of an impact device according to this invention;

FIG. 4 is a side view of the electric nail gun shown in FIG. 3;

FIG. 5 is a sectional view of the electric nail gun shown in FIG. 3, illustrating a pre-firing position of an impact block;

FIG. 6 is a sectional view taken along Line VI-VI in FIG. 5;

FIG. 7 is a sectional view of the electric nail gun shown in FIG. 3, illustrating a pre-firing position of the impact block; and

FIG. 8 is a sectional view taken along Line VIII-VIII in FIG. 7.

### DETAILED DESCRIPTION OF THE PREFERRED EMBODIMENT

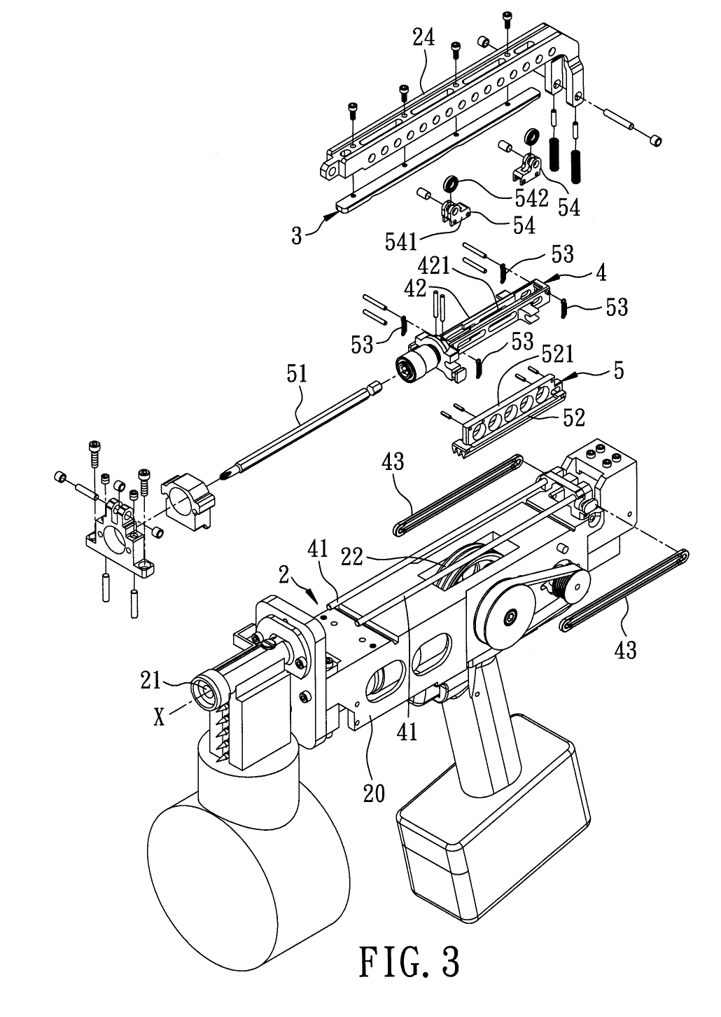

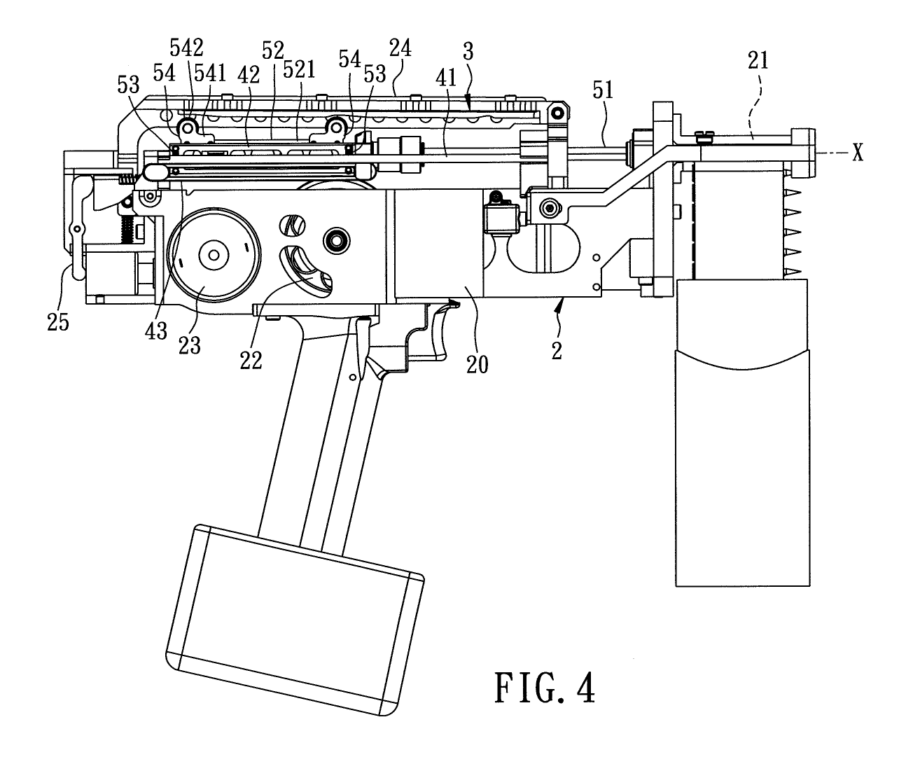

Referring to FIGS. 3 and 4, the preferred embodiment of an impact device according to this invention is adapted to be mounted on an electric nail gun 2. The electric nail gun 2 includes a supporting frame 20, a nail passage 21 formed in a side portion of the supporting frame 20 and extending along an axis (X), a flywheel 22 disposed pivotally on the supporting frame 20, a motor 23 disposed on the supporting frame 20 for driving rotation of the flywheel 22, a swing arm 24 disposed pivotally on the supporting frame 20, and a driving unit 25 operable for rotating the swing arm 24 toward or away from the flywheel 22. The impact device includes a guide rail 3, a moving unit 4, and an impact unit 5.

The guide rail 3 is disposed on a side surface of the swing arm 24 facing toward the flywheel 22.

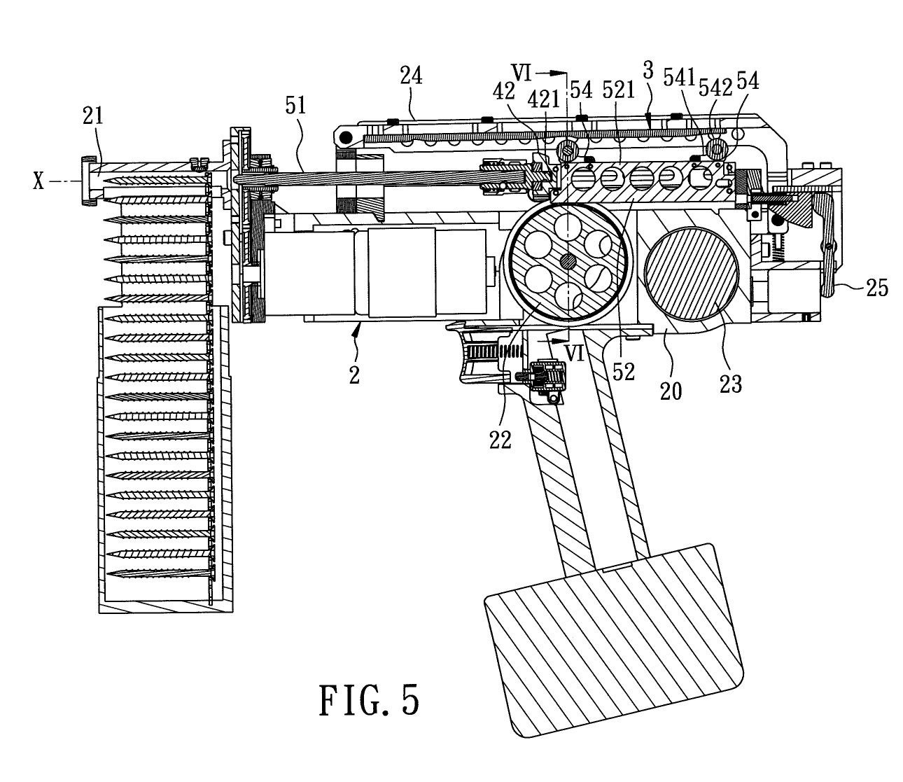

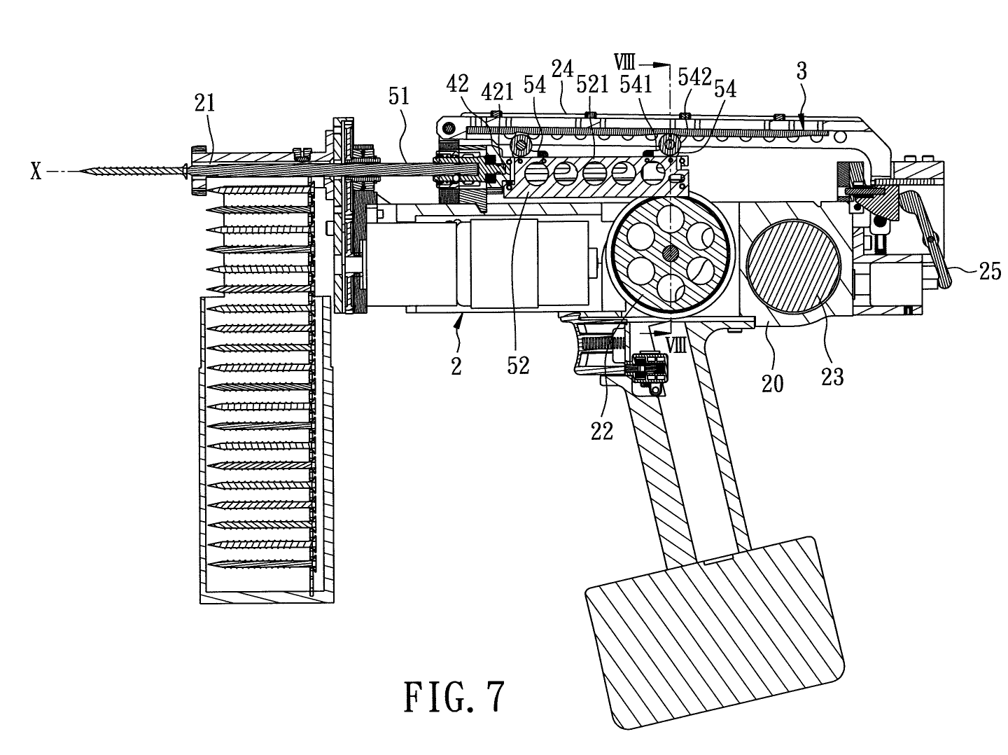

The moving unit 4 includes two guide rods 41, a sliding block 42, and two resilient members 43. The guide rods 41 are disposed on the supporting frame 20 and above the flywheel 22. Each of the guide rods 41 extends along a direction parallel to the axis (X). The sliding block 42 is disposed movably on the guide rods 41, is formed with a channel 421 extending along a gravity direction perpendicular to the axis (X), and is movable between a pre-firing position shown in FIG. 5 and distal from the nail passage 21, and a firing position shown in FIG. 7 and proximate to the nail passage 21. The resilient members 43 are connected between the supporting frame 20 and the sliding block 42 along the axis (X) for biasing the sliding block 42 toward the pre-firing position.

The impact unit 5 includes a nail striker rod 51, an impact block 52, a plurality of return springs 53, and two roller units 54. The nail striker rod 51 is connected to the sliding block 42 in a known manner, and is aligned with the nail passage 21. The impact block 52 is disposed floatably on the sliding block 42, is movable relative to the sliding block 42 along the gravity direction, and is formed with a projection 521 extending through the channel 421. The return springs 53 are connected between the sliding block 42 and the impact block 52 for biasing the impact block 52 to move away from the flywheel 22 to abut resiliently against the sliding block 42. Each roller unit 54 includes a roller seat 541 connected fixedly to the projection 521 of the impact block 52, and a roller 542 disposed pivotally on the roller seat 541 and movable on the guide rail 3.

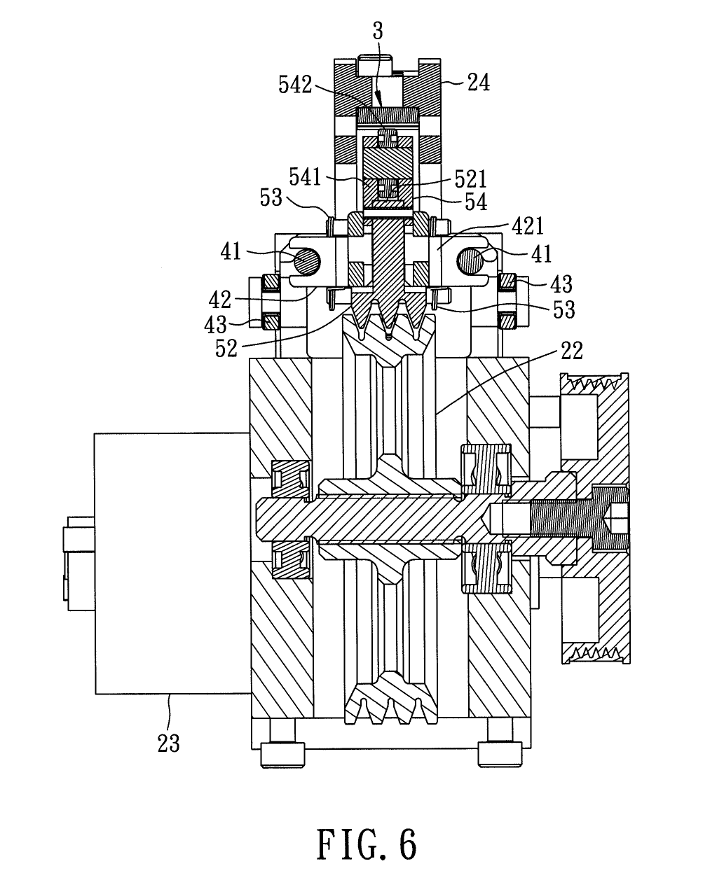

With further reference to FIGS. 5 and 6, normally, the swing arm 24 is not subjected to any external force, and is far away from the flywheel 22, so as not to press the roller unit 54 on the impact block 52. Hence, the impact block 52 is biased by the return springs 53 to abut resiliently against the sliding block 42, and the sliding block 42, together with the impact block 52, is biased by the resilient member 43 to the pre-firing position. In this case, the flywheel 22 is spaced apart from the impact block 52 by a distance of about 0.5 mm.

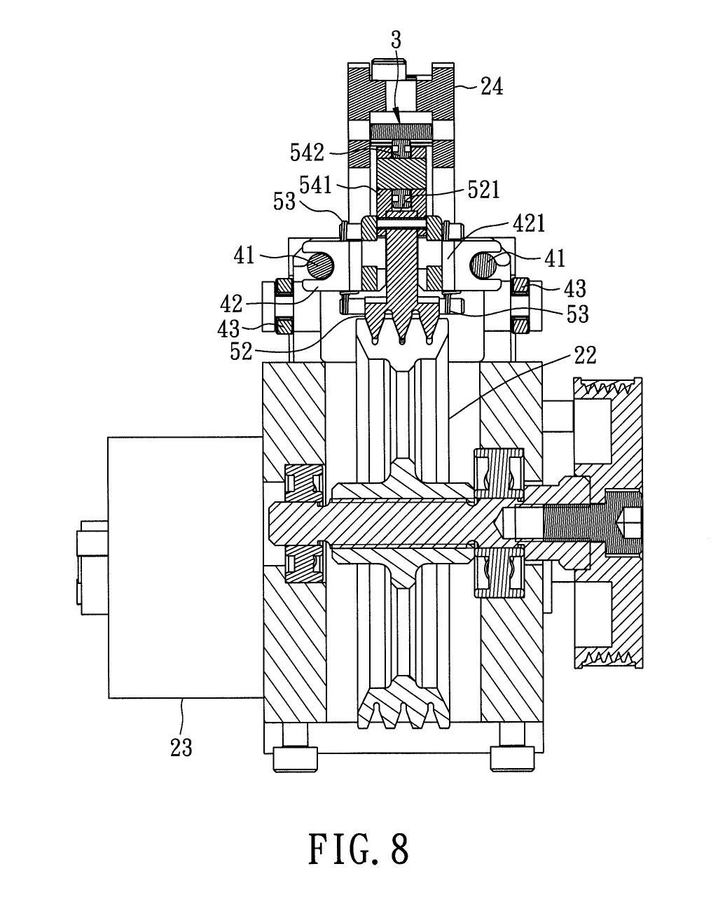

Referring to FIGS. 7 and 8, when the motor 23 is operated to drive rotation of the flywheel 22, the flywheel 22 rotates idly to store a kinetic energy. When the swing arm 24 is driven by the driving unit 25 to rotate toward the flywheel 22, the guide rail 3 moves the roller unit 54 and the impact block 52 toward the flywheel 22 against the biasing action of the return springs 53 until the impact block 52 comes into contact with the flywheel 22.

Hence, a power is transmitted from the motor 23 to the impact block 52 through the flywheel 22, so that the impact block 52, together with the sliding block 42, is thrown to move the rollers 542 on the guide rail 3. As a consequence, the sliding block 42 is moved to the firing position, and the nail striker rod 51 is moved in the nail passage 21 to perform a nail striking operation.

In view of the above, the impact device of this invention has the following advantages:
1. Since the impact block 52 is not co-rotatable with the swing arm 24, it can be designed to move along the axis (X). In addition, the impact block 52 can move floatingly on the sliding block 42 along a direction perpendicular to the axis (X). With such designs, the moving direction of the impact block 52 and the nail striking direction of the nail striker rod 51 can be controlled to be the same.
2. Since the cross sectional shape of the nail striker rod 51, e.g., circle and semicircle, can be typically adjusted according to that of the nail to be struck, if the nail striking direction of the nail striker rod 51 and the extending direction of the nail passage 21 are the same, the service life of the electric nail gun 2 can be prolonged, and the nail can be driven into a workpiece along a straight line so as to prevent the nail from being inclined with respect to a surface of the workpiece contacting the electric nail gun, thereby improving the nail striking effect.

With this invention thus explained, it is apparent that numerous modifications and variations can be made without departing from the scope and spirit of this invention. It is therefore intended that this invention be limited only as indicated by the appended claims.

I claim:

1. An impact device adapted for use on an electric nail gun, the electric nail gun including a supporting frame, a nail passage formed in the supporting frame and extending along an axis, a flywheel disposed pivotally on the supporting frame, a swing arm disposed pivotally on the supporting frame, and a driving unit for driving the swing arm to rotate toward or away from the flywheel, said impact device comprising:
a sliding block adapted to be movable relative to the supporting frame along the axis between a pre-firing position distal from the nail passage, and a firing position proximate to the nail passage;
a nail striker rod connected to said sliding block and adapted to align with the nail passage; and
an impact block disposed floatably on said sliding block and movable relative to said sliding block in a gravity direction perpendicular to the axis such that, when rotating toward the flywheel, the swing arm contacts and pushes said impact block to press against the flywheel, so as to move said impact block along the axis, thereby driving movement of said sliding block from the pre-firing position to the firing position, which results in movement of said striker rod in the nail passage.

2. The impact device as claimed in claim 1, further comprising at least one guide rod adapted to be disposed on the supporting frame and above the flywheel, said sliding block being connected movably to said guide rod.

3. The impact device as claimed in claim 2, further comprising a plurality of return springs, said sliding block being formed with a channel extending along the gravity direction, said return springs being connected between said sliding block and said impact block along the gravity direction for biasing said impact block to move away from the flywheel to abut resiliently against said sliding block, so that said impact block is floatable relative to said sliding block.

4. The impact device as claimed in claim 3, further comprising at least one roller unit, said impact block is formed with a projection extending through said channel, said roller unit including a roller seat connected fixedly to said projection, and a roller disposed rotatably on said roller seat and adapted to move on the swing arm.

5. The impact device as claimed in claim 4, further comprising a guide rail adapted to be disposed on a side of the swing arm facing toward the flywheel.

6. The impact device as claimed in claim 1, further comprising a resilient member adapted to be connected between the supporting frame and said sliding block for biasing said sliding block toward the pre-firing position.
